(19) United States
(12) Patent Application Publication
(10) Pub. No.: US 2003/0011214 A1
(43) Pub. Date: Jan. 16, 2003

(54) Vehicle headliner and method for making same

(76) Inventors: Sunil K. Gupte, Livonia, MI (US); George B. Byma, Clarkston, MI (US); Randall A. Gage, Troy, MI (US); David M. Emerling, West Bloomfield, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(21) Appl. No.: 10/191,592

(22) Filed: Jul. 9, 2002

Related U.S. Application Data
(60) Provisional application No. 60/304,299, filed on Jul. 10, 2001.

(51) Int. Cl. B60R 13/02; B29C 44/00

(52) U.S. Cl. 296/214; 264/50

(57) ABSTRACT

A vehicle headliner assembly (10) and a method for injection molding the assembly by injecting into a mold 24 a single phase solution of an inert gas within a polymeric resin (16) to provide a microcellular headliner (14) with an 5 average cell size less than 100 microns and a cell density greater than 10⁶ cell/cm³ and with headliner components (20) molded with the headliner. The inert gas utilized may be carbon dioxide, nitrogen and mixtures of carbon dioxide and nitrogen.

### CROSS-REFERENCE TO RELATED APPLICATIONS

This application claims the benefit of U.S. provisional application Serial No. 60/304,299 filed Jul. 10, 2001.

### BACKGROUND OF THE INVENTION

1. Field of the Invention

This invention relates to a vehicle headliner assembly and also relates to a method for making the vehicle headliner assembly.

2. Background Art

Vehicle headliners are utilized to cover the lower side of vehicle roofs in order to provide an aesthetically appealing appearance. After forming of the headliners from various materials including polyurethane, fiberglass or scrim layers, etc., various headliner components are conventionally subsequentially mounted on the headliner to provide. a vehicle headliner assembly prior to its attachment as an assembly to the associated vehicle roof interior. Due to the relatively long front-to-rear and side-to-side dimensions of vehicle headliners as compared to their thickness, it is difficult to inject a formable liquid mixture for flow to all extremities of a mold for molding of the headliner.

References noted in connection with an investigation conducted in connection with the present invention include U.S. Pat. Nos.: 4,172,918 Doerer; 4,840,832 Weinle et al.; 4,958,878 Kempkers; 5,011,218 Danner et al.; 5,082,716 Satterfield et al.; 5,591,289 Souders et al.; 5,660,908 Kelman et al.; 5,683,796 Kornylo et al.; 5,688,022 Adams et al.; 5,853,843 Patel et al.; 5,879,802 Beard et al.; 5,921,620 Youens; 6,062,635 Learman et al.; 6,070,902 Kowalski et al.; 6,086,145 Wandyez; 6,120,090 Van Ert et al; and 6,120,091 Reich et al.

### SUMMARY OF THE INVENTION

An object of the present invention is to provide an improved vehicle headliner assembly.

In carrying out the above object, the vehicle headliner assembly of the invention includes an injection molded microcellular headliner of a polymeric resin having cells of an average cell size less than 100 microns and a cell density greater than 106 cells/cm³ and with the cells blown with an inert gas. The headliner assembly also includes headliner components molded in the headliner.

In the preferred construction of the vehicle headliner assembly, the inert gas is carbon dioxide, nitrogen or mixtures of carbon dioxide and nitrogen.

The components molded in the headliner are selected from the group consisting of wires(s) and attachment(s) therefor, head impact formation(s) and structure(s), overhead console(s) and attachment(s) therefor, visor attachment(s), coat hook(s) and attachment(s) therefor, grab handle(s) and attachment(s) therefor, light(s) and attachment(s) therefor, acoustic member(s) and attachment(s) therefor, air distributor(s) and attachment(s) therefor, sunroof member(s) and attachment(s) therefor, and mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s) therefor; reinforcing ribs; and texturing of an exposed surface of the headliner assembly.

The vehicle headliner assembly may also include a cover.

Another object of the present invention is to provide an improved method for making a vehicle headliner assembly.

In carrying out the immediately preceding object, the method for making a vehicle headliner assembly in accordance with the invention involves heating a polymeric resin in preparation for the injection molding, introducing into the resin an inert gas and pressurizing thereof to provide a single phase solution of heated resin and supercritical inert gas, and injecting the single phase solution of the heated resin and supercritical inert gas into the injection mold to mold a microcellular headliner of the resin with cells of an average cell size less than 100 microns and a cell density greater than 10⁶ cells/cm³ with the cells blown with the inert gas, and with headliner components being molded with the headliner to provide the headliner assembly.

In the preferred practice of the method, the inert gas used is carbon dioxide, nitrogen or mixtures of carbon dioxide and nitrogen.

The headliner components molded in the mold can be wire(s) and attachment(s) therefor, head impact formation(s) and structure(s), overhead console(s) and attachment(s) therefor, visor attachment(s), coat hook(s) and attachment(s) therefor, grab handle(s) and attachment(s) therefor, light(s) and attachment(s) therefor, acoustic member(s) and attachment(s) therefor, air distributor(s) and attachment(s) therefor, sunroof member(s) and attachment(s) therefor, mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s) therefor; reinforcing ribs; and texturing of an exposed surface of the headliner assembly.

In one practice of the method for making a vehicle headliner component(s) and attachment(s) therefor are introduced into the mold for insert type molding with the headliner, while another practice of the method has the vehicle headliner component(s) and attachment(s) therefor molded with the mold from the single phase solution of heated resin and supercritical inert gas.

The method for making a vehicle headliner assembly may also be performed by providing a cover layer on the headliner.

### BRIEF DESCRIPTION OF THE DRAWINGS

FIG. 1 is a plan view of a vehicle headliner assembly constructed in accordance with the invention.

FIG. 2 is a partial sectional view taken through the headliner assembly along the direction of line 2-2 in FIG. 1.

FIG. 2a is a partial sectional view similar to FIG. 2 showing another embodiment of the headliner which includes a cover.

FIG. 3 is a greatly enlarged view of a portion of the cross section shown in FIG. 2 to illustrate its microcellular construction.

FIG. 4 is a diagrammatic view illustrating the method for making the headliner assembly.

FIG. 5 is a schematic view that illustrates injection molding apparatus for performing the method to make the headliner assembly.

### DETAILED DESCRIPTION OF THE PREFERRED EMBODIMENT

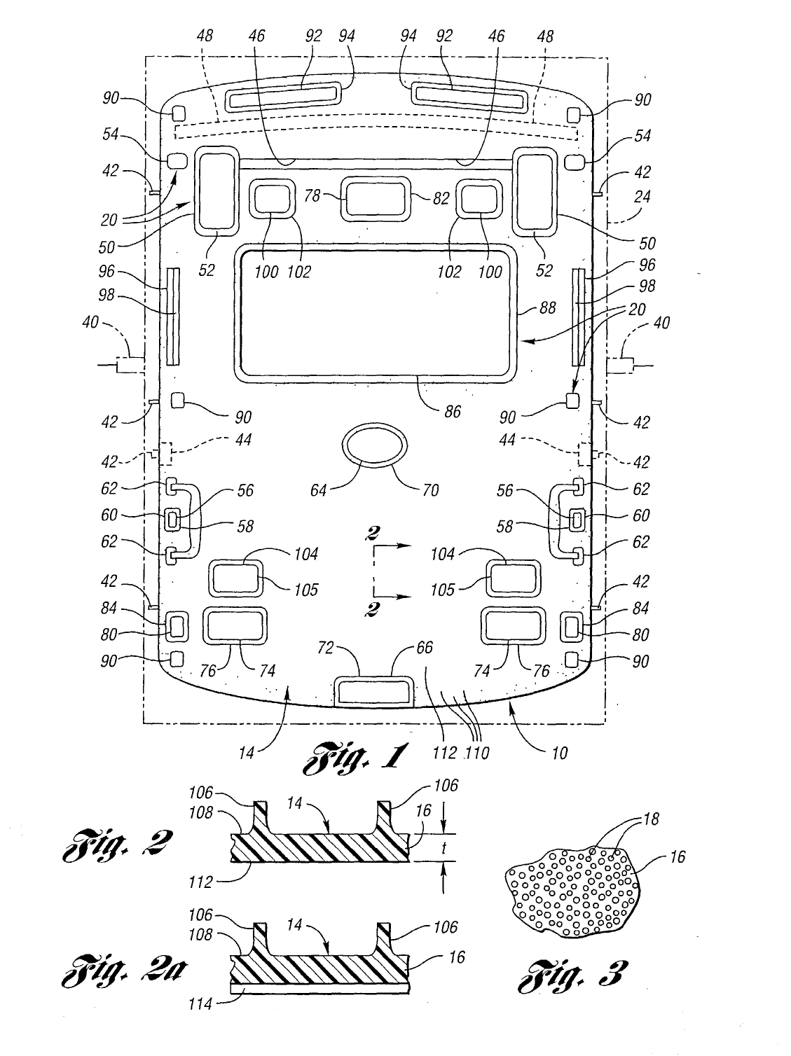

With reference to FIG. 1 of the drawings, a vehicle headliner assembly constructed in accordance with the invention is generally indicated by 10. The construction of the headliner 10 and the method of making the headliner assembly utilizing apparatus 12 shown in FIG. 5 will be described in an integrated manner to facilitate an understanding of all aspects of the invention.

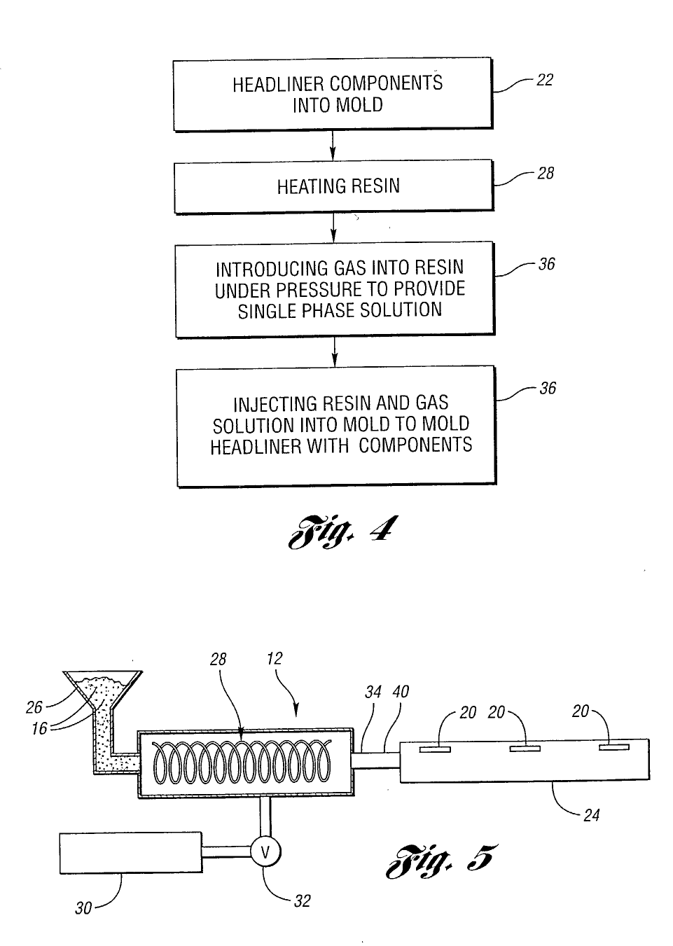

With reference to FIGS. 1-3, the headliner assembly 10 includes a headliner 14 of an injection molded microcellular construction made from a polymeric resin 16 shown in FIG. 2, which will normally be a thermoplastic resin such as polypropylene, polyethylene or polyethylene terephthalate, etc., or mixtures. As shown in FIG. 3, the resin 16 includes cells 18 that are blown with an inert gas and have an average cell size of less than 100 microns as well as having a cell density greater than 10⁶ cells/cm³. The headliner assembly 10 also includes headliner components, individually and collectively indicated by 20, that are molded in the headliner.

With combined reference to FIGS. 4 and 5, the method for making the headliner assembly in one practice involving insert molding is performed by an introduction step 22 (FIG. 4) of headliner components 20 into a mold 24. The resin 16 as shown in FIG. 5 is received from a hopper 26 within a conventional injection screw 28 to provide heating of the resin as also identified by step 28 in FIG. 4. It should be appreciated that the steps of introducing the headliner components into the mold and heating the resin can be performed sequentially with either before the other as well as being performed partially or fully concurrently with each other.

An inert gas is supplied such as from a pressurized source 30 through an associated control valve 32 and is fed to the injection screw 28 into the resin. The resin and the inert gas are heated and pressurized by the screw rotation and/or the pressure of the inert gas source such that the gas is in a supercritical state and is in a single phase solution with the resin at the screw outlet 34 as identified by step 36 (FIG. 4). As identified by step 38, the single phase solution of resin and inert gas is then injected through one or more mold inlets 40 into the mold 24 in which the headliner components are mounted so as to mold the headliner 10 previously described in connection with FIG. 1 with the headliner components molded as inserts with the headliner.

In another practice of the invention, the mold 24 is formed to provide the headliner components 20 by the molding. Thus, in that practice, there is no initial insertion of the headliner components 20 into the mold prior to the injection.

The manner in which the supercritical inert gas and the polymeric resin provide a single phase solution reduces the viscosity of the resin such that the liquid material can flow throughout the mold even though the mold has a relatively thin construction in comparison to its lateral width and longitudinal length. More specifically, headliners that are approximately 58 inches wide and 80 inches long with only a thickness t (FIG. 2) of three to four millimeters can still have the mold filled during the injection. Furthermore, the gas cells 18 reduce the weight of the resultant headliner and testing to date has indicated that such weight reduction can be on the order of about 15 percent. The reduction in viscosity also allows the molding to be performed with a reduced mold clamp pressure since the material flows better as previously mentioned and it is believed that it will also permit thinner headliners to be manufactured. Also, the molding of the headliner components 20 reduces post molding assembly operations and the cost involved. It should be appreciated that some of the inert gas may come out of solution with the resin during the molding process without preventing the rest of the inert gas from staying in solution to provide the microcellular headliner. The inert gas will initially fill the cells; however, there may be some gas migration of the inert gas and atmospheric gas after passage of time such that the inert gas is replaced at least to some extent by atmospheric gas.

For a more detailed description of the injection molding and details thereof, reference should be made to U.S. Pat. Nos.: 6,169,122 Blizard et al.; 6,231,942 Blizard et al.; 6,235,380 Tupil et al.; 6,284,810 Burnham et al.; 6,294,115 Blizard et al.; 6,322,347 Xu; and 6,376,059 Anderson et al. as well as references cited in these patents, all of which are hereby incorporated by reference.

As mentioned above, the headliner components 20 that are molded in the headliner by the single phase solution of resin and supercritical inert gas facilitate the manufacturing of the headliner assembly by eliminating post molding attachment operations. These headliner components may include wires 42 and attachments 44 such that there is one or more attachment for each wire. In addition, for energy absorption, the headliner components may include one or more head impact formation 46 as well as one or more head impact structure 48. One or more overhead console 50 and an attachment 52 for each overhead console can also be utilized as well as one or more visor attachment 54. Furthermore, one or more coat hook 56 and grab handle 58 as well as respective attachments 60 and 62 therefor can also be incorporated into the headliner by the molding previously described. Likewise, lights such as a dome light 64 and a center high interior mounted stop light 66 and associated attachments (e.g. bases) 70 and 72 therefor are also included as well as acoustic members 74 and associated attachments 76 are also provided. In addition, air distributors such as a front central air distributor 78 and rear side air distributors 80 as well as respective attachments 82 and 84 are also incorporated into the headliner assembly. Furthermore, a sunroof member 86 and an attachment (e.g. bezel) 88 therefor are also incorporated into the headliner assembly as well as mounting attachments 90 for mounting the headliner on the vehicle roof. The headliner components may also include air bag(s) 92 and attachment(s) 94 therefor, air curtain(s) 96 and attachment(s) 98 therefor, video monitor(s) 100 and attachment(s) 102 therefor, audio member(s) 104 and attachment(s) 105 therefor, reinforcing rib(s) 106 (FIGS. 2 and 2a) on the hidden side 108 of the headliner 14, and texturing 110 on the exposed surface 112 of the headliner.

As illustrated in FIG. 2a, the headliner assembly may also include a cover 114 that defines the exposed surface of the headliner. This cover may be a separate layer that is molded by the insert molding process described above within the mold with the headliner or may be secured to the headliner after the molding by a post adhesive attachment. The cover layer may partially or fully cover the headliner and may have decorative printing. It is possible for the cover to include a cushion foam and a protective layer. The cover may be fabric, vinyl, or a plastic film, etc. together with the foam backing and the protective layer.

While the preferred embodiment and manner of practicing the invention have been described in detail, those familiar with the art to which this invention relates will recognize various alternative designs and embodiments as well as other ways of practicing the invention as described by the following claims.

What is claimed is:

1. A vehicle headliner assembly comprising:
an injection molded microcellular headliner of a polymeric resin having cells of an average cell size less than 100 microns and a cell density greater than 10⁶ cells/cm³ and with the cells blown with an inert gas; and
headliner components molded in the headliner.

2. A vehicle headliner assembly as in claim 1 wherein the inert gas is selected from the group consisting of carbon dioxide, nitrogen and mixtures of carbon dioxide and nitrogen.

3. A vehicle headliner assembly as in claim 1 wherein the components molded in the headliner are selected from the group consisting of wire(s) and attachment(s) therefor, head impact formation(s) and structure(s), overhead console(s) and attachment(s) therefor, visor attachment(s), coat hook(s) and attachment(s) therefor, grab handle(s) and attachment(s) therefor, light(s) and attachment(s) therefor, acoustic member(s) and attachment(s) therefor, air distributor(s) and attachment(s) therefor, sunroof member(s) and attachment(s) therefor, mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s); therefor; reinforcing ribs; and texturing of an exposed surface of the headliner assembly.

4. A vehicle headliner assembly as in claim 1 further including a cover.

5. A vehicle headliner assembly comprising:
an injection molded microcellular headliner of a polymeric resin having cells of an average cell size less than 100 microns and a cell density greater than 10⁶ cells/cm³ and with the cells blown with an inert gas selected from the group consisting of carbon dioxide, nitrogen and mixtures of carbon dioxide and nitrogen; and
headliner components molded in the headliner and selected from the group consisting of wire(s) and attachment(s) therefor, head impact formation(s) and structure(s), overhead console(s) and attachment(s) therefor, visor attachment(s), coat hook(s) and attachment(s) therefor, grab handle(s) and attachment(s) therefor, light(s) and attachment(s) therefor, acoustic member(s) and attachment(s) therefor, air distributor(s) and attachment(s) therefor, sunroof member(s) and attachment(s) therefor, mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s) therefor; reinforcing ribs; and texturing of an exposed surface of the headliner assembly.

6. A method for making a vehicle headliner assembly comprising:
heating a polymeric resin in preparation for injection molding;
introducing into the resin an inert gas and pressurizing thereof to provide a single phase solution of heated resin and supercritical inert gas; and
injecting the single phase solution of the heated resin and supercritical inert gas into the injection mold to mold a microcellular headliner of the resin with cells of an average cell size less than 100 microns and a cell density greater than 10⁶ cells/cm³ and with the cells blown with the inert gas, and with headliner components being molded with the headliner to provide the headliner assembly.

7. A method for vehicle headliner assembly as in claim 6 wherein the inert gas is selected from the group consisting of carbon dioxide, nitrogen and mixtures of carbon dioxide and nitrogen.

8. A method for making a vehicle headliner assembly as in claim 5 wherein the components molded in the headliner are selected from the group consisting of wire(s) and attachment(s) therefor, head impact formation(s) and structure(s), overhead console(s) and attachment(s) therefor, visor attachment(s), coat hook(s) and attachment(s) therefor, grab handle(s) and attachment(s) therefor, light(s) and attachment(s) therefor, acoustic member(s) and attachment(s) therefor, air distributor(s) and attachment(s) therefor, sunroof member(s) and attachment(s) therefor, mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s) therefor; reinforcing ribs; and texturing of an exposed surface of the headliner assembly.

9. A method for making a vehicle headliner assembly as in claim 6 wherein vehicle headliner component(s) and attachment(s) therefor are introduced into the mold for insert type molding with the headliner.

10. A method for making a vehicle headliner assembly as in claim 6 wherein vehicle headliner component(s) and attachment(s) therefor are molded within the mold from the single phase solution of heated resin and supercritical inert gas.

11. A method for making a vehicle headliner assembly as in claim 6 wherein a cover is provided on the headliner.

12. A method for making a vehicle headliner assembly comprising:
heating a polymeric resin in preparation for injection molding;
introducing into the resin an inert gas selected from the group consisting of carbon dioxide, nitrogen and mixtures of carbon dioxide and nitrogen and pressurizing thereof to provide a single phase solution of heated resin and supercritical inert gas; and
injecting the single phase solution of the heated resin and supercritical inert gas therein into the injection mold to mold a microcellular headliner of the resin with cells of an average cell size less than 100 microns and a cell density greater than 10⁶ cells/cm³ and with the cells blown with the inert gas, and with headliner components being molded with the headliner to provide the headliner assembly and selected from the group consisting of wire(s) and attachment(s) therefor, head impact formation(s) and structure(s), overhead console(s) and attachment(s) therefor, visor attachment(s), coat hook(s) and attachment(s) therefor, -grab handle(s) and attachment(s) therefor, light(s) and attachment(s) therefor, acoustic member(s) and attachment(s) therefor, air distributor(s) and attachment(s) therefor, sunroof member(s) and attachment(s) therefor, mounting attachment(s) for the headliner, storage bin(s) and attachment(s) therefor; air bag(s) and attachment(s) therefor; air curtain(s) and attachment(s) therefor; video monitor(s) and attachment(s) therefor; audio member(s) and attachment(s) therefor; reinforcing ribs; and texturing of an exposed surface of the headliner assembly.
